(19) United States
(12) Patent Application Publication
(10) Pub. No.: US 2010/0107154 A1
(43) Pub. Date: Apr. 29, 2010

(54) METHOD AND SYSTEM FOR INSTALLING AN OPERATING SYSTEM VIA A NETWORK

(76) Inventors: Deepak BRAHMAVAR, Bangalore (IN); Rupa Ramakrishna, Bangalore (IN); Sunil Vishwanathpur Lakshminarasimha, Bangalore (IN)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/327,825

(22) Filed: Dec. 4, 2008

(30) Foreign Application Priority Data
Oct. 16, 2008 (IN) 2542/CHE/2008

(51) Int. Cl. G06F 9/445; G06F 17/30; G06F 15/177

(52) U.S. Cl. 717/176; 709/222; 707/E17.01; 707/E17.032

(57) ABSTRACT

A system and method for handling network interface error during operating system installation on a client device by an installation server via a network is disclosed. In one embodiment, the method includes determining available network interface modules in the client device when a request for an installation of the OS is forwarded by the client device, initiating the installation of the OS using a first network interface module of the available network interface modules, switching to a second network interface module of the available network interface modules when the first network interface module becomes inoperable due to an error, and continuing the installation of the OS on the client device using the second network interface module. The method further includes downloading the probe module from the installation server to the client device using a default connection between the installation server and the client device.

### RELATED APPLICATIONS

Benefit is claimed under 35 U.S.C. 119(a)-(d) to Foreign application Serial No. 2542/CHE/2008 entitled “METHOD AND SYSTEM FOR INSTALLING AN OPERATING SYSTEM VIA A NETWORK” by Hewlett-Packard Development Company, L.P., filed on 16 Oct. 2008, which is herein incorporated in its entirety by reference for all purposes.

### BACKGROUND

During installation of operating systems over a network, various network interface card (NIC) related errors may happen. For example, an NIC may become unresponsive due to a hardware problem. In addition, there may be a link connectivity problem associated with the NIC. During regular system runtime, the network errors may be handled using a custom made or off-the-shelf solution. For example, Auto port aggregation (APA) is a software product which provides maximized overall throughput with enhanced failover protection by aggregating multiple network interfaces into a single logical interface and automatically detecting and handling network failures, thus providing high availability. IP network multi-pathing (IPMP) groups two or more identical network cards or non-identical network cards conforming to the same protocol which are able to operate at a common speed into a group to provide load balancing among the interfaces configured into the group. Upon detecting an error, IP links to the affected network interface card automatically fail over to another available network interface card in the group without any noticeable loss or degradation of communication via the network.

Although the two techniques (i.e., APA and IPMP) may be effective in providing fault tolerance at software level during runtime of a system (e.g., the system with its operating system (OS) up and running), they cannot be used when the OS is not yet installed in the system (e.g., bare machine).

Thus, it may often be the case where the NIC related errors may lead to a system crash or system hang, thus causing corruption of the system during the installation of the OS. Although multiple NICs may be available in the system during the OS installation, the existing technologies may not be fully equipped to handle such errors even with the available resources.

### BRIEF DESCRIPTION OF THE DRAWINGS

Embodiments of the present invention are illustrated by way of an example and not limited to the figures of the accompanying drawings, in which like references indicate similar elements and in which:

FIG. 1 is a block diagram of an exemplary network system for installing an OS using a first network interface module, according to one embodiment.

FIG. 2 is a block diagram of an exemplary network system for continuing the installation the OS using a second network interface module when the first network interface module becomes inoperable, according to one embodiment.

FIG. 3 is a block diagram of an exemplary network system for installing an OS using a default network interface card (NIC), according to one embodiment.

FIG. 4 is a block diagram of an exemplary network system for continuing the installation the OS using a second NIC when the first NIC becomes inoperable, according to one embodiment.

FIG. 5 is a process flow chart of an exemplary method for seamlessly performing an installation of an OS using multiple network interface modules, according to one embodiment.

FIG. 6 is a diagrammatic system view of a data processing system in which any of the embodiments disclosed herein may be performed, according to one embodiment.

Other features of the present embodiments will be apparent from the accompanying drawings and from the detailed description that follows.

### DETAILED DESCRIPTION

A system and method for handling network interface error during operating system installation over a network is disclosed. In the following detailed description of the embodiments of the invention, reference is made to the accompanying drawings that form a part hereof, and in which are shown by way of illustration specific embodiments in which the invention may be practiced. These embodiments are described in sufficient detail to enable those skilled in the art to practice the invention, and it is to be understood that other embodiments may be utilized and that changes may be made without departing from the scope of the present invention. The following detailed description is, therefore, not to be taken in a limiting sense, and the scope of the present invention is defined only by the appended claims.

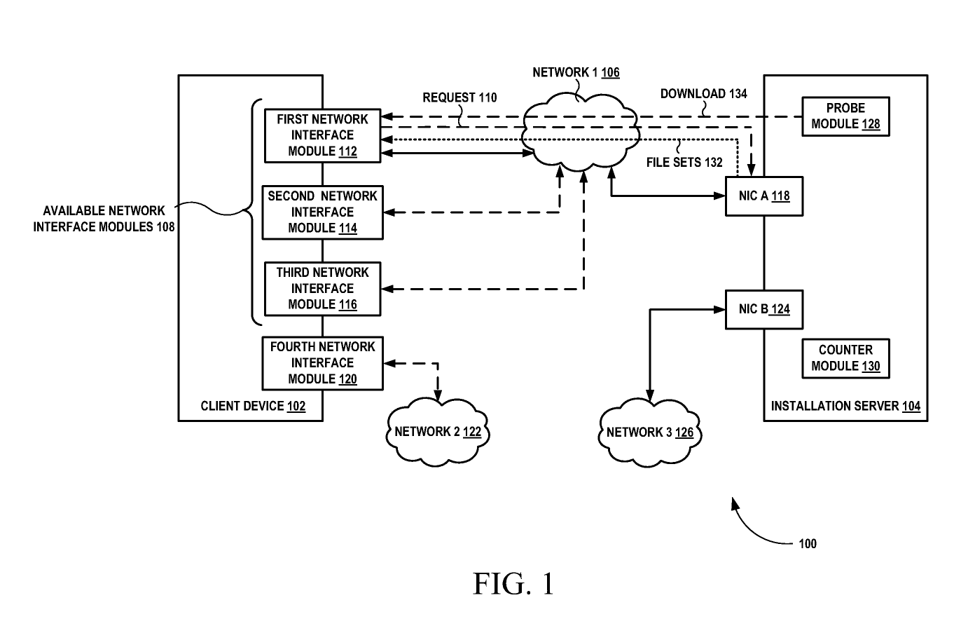

FIG. 1 is a block diagram of an exemplary network system 100 for installing an OS using a first network interface module 112, according to one embodiment. Particularly, FIG. 1 illustrates an installation server system for installing the operating system (OS) on a client device 102 via a network (e.g., the network 1 106). As shown in FIG. 1, the exemplary network system 100 includes the client device 102, an installation server 104, and the network 1 106. Further as shown in FIG. 1, the client device 102 includes available network interface modules 108 that are connected to the same network 1 106 as the installation server 104, and a fourth network interface module 120 connected to a network 2 122. Furthermore, the available network interface modules 108 include the first network interface module 112, a second network interface module 114, and a third network interface module 116 connected to the network 1 106.

Further as shown in FIG. 1, the installation server 104 includes a network interface card (NIC) A 118 connected to the network 1 106 and a NIC B 124 connected to the network 3 126. The installation server 104 also includes a probe module 128 and a counter module 130.

The Pseudo-code for implementing the installation of the OS is listed in APPENDIX “A” and APPENDIX “B”. In this implementation, the probe module 128 is used to determine the available network interface modules 108 in the client device 102 when a request 110 for the installation of the OS via the network (e.g., the network 1 106) is initiated by the client device 102. In one exemplary implementation, the probe module 128 is downloaded (e.g., via the download link 134 shown in FIG. 1) to the client device 102 to determine the available network interface modules 108 using a default connection to the client device 102. In one example embodiment, the probe module 128 is operable for scanning of the available network interface modules 108 without a support of the OS. Further as shown in FIG. 1, the default connection to the client device 102 is via the first network interface module 112.

During the start of the installation, the installation of the OS is initiated using the first network interface module 112 of available network interface modules 108 in the client device 102. Further, the counter module 130 tracks a transfer of a plurality of file sets 132 to the client device 102 for the installation of the OS. For example, the counter module 130 maintains a count for each instance of the OS installation in which the installation server 104 is participating. The counter module 130 is updated in accordance to the number of file sets 132 transmitted to the client device 102. In one example embodiment, the client device 102 also includes a similar counter to track the plurality of file sets 132 received. In another example embodiment, the counter module 130 may be based on a simple data structure (e.g., variable).

In operation, the available network interface modules 108 of the client device 102 are determined when the request 110 for the installation of the OS is forwarded by the client device 102. In one exemplary implementation, the probe module 128 is downloaded from the installation server 104 to the client device 102 using the default connection (e.g., the first network interface module 112) between the installation server 104 and the client device 102. In one embodiment, the probe module may be communicated to the client device based on a trivial file transfer protocol (TFTP).

In one embodiment, the available network interface modules 108 are determined by the probe module 128 which is operable for scanning the available network interface modules 108 without the support of the OS. In one example embodiment, the available network interface modules 108 are scanned using respective firmware interfaces of the available network interface modules 108. This information is used to obtain respective Internet Protocol (IP) addresses for the available network interface modules 108 from a dynamic host configuration protocol server.

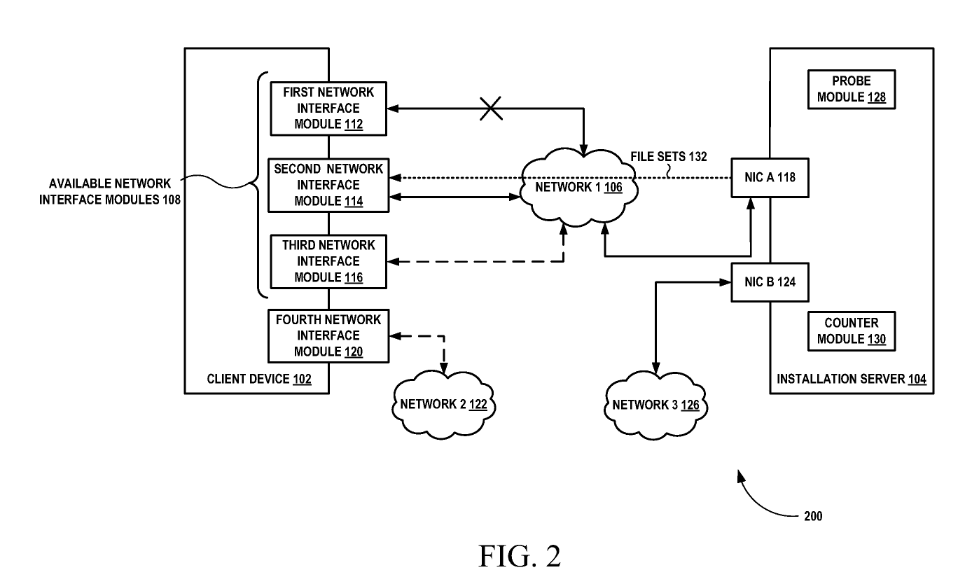

Further in operation, the installation of the OS is initiated using the first network interface module 112 of the available network interface modules 108. Further, a transfer of a plurality of file sets 132 to the client device 102 during the installation of the OS is tracked through the counter module 130 residing in the installation server 104. In one exemplary implementation, the file sets 132 for the installation of the OS are communicated based on a trivial file transfer protocol (TFTP). Further, the installation of the OS is continued using the second network interface module 114 as illustrated in FIG. 2.

FIG. 2 is a block diagram of an exemplary network system 200 for continuing the installation of the OS using the second network interface module 114 when the first network interface module 112 becomes inoperable, according to one embodiment. As shown in FIG. 2, the installation of the OS is switched from the first network interface module 112 to the second network interface module 114 of the available network interface modules 108 when the first network interface module 112 becomes inoperable due to an error. In one example embodiment, the switching to the second network interface module 114 is performed if the transfer of the plurality of file sets 132 to the client device 102 via the first network interface module 112 is not detected by the counter module 130 for more than a threshold time interval.

Further in operation, the installation of the OS is continued using the second network interface module 114 of the available network interface modules 108 when the first network interface module 112 is inoperable due to the error. In one embodiment, the first network interface module 112 is functionally independent from the second network interface module 114. For example, the error includes a hardware error of the first network interface module 112 and/or a link connectivity failure with the first network interface module.

In one exemplary implementation, the installation of the OS is continued using the second network interface module 114 if the transfer of the plurality of file sets 132 to the client device 102 via the first network interface module 112 is not detected by the counter module 130 for more than a threshold time interval.

In one embodiment, the installation of the OS is maintained by performing a handshake between the installation server 104 and the second network interface module 114 (e.g., used to re-establish the connection between the client device 102 and the installation server 104). Additionally, the transfer of the plurality of the file sets 132 is reinstated starting from the interrupted file set using the second network interface module 114 based on information which tracks the transfer of the plurality of file sets 132 by the counter module 130. In one example embodiment, the OS installation is performed based on a bootstrap protocol (BOOTP).

It is appreciated that, the installation of the OS continues with re-transmission of file set whose transfer has been interrupted, thereby ensuring the continuity in the transfer of the plurality of file sets 132 and consequently the installation of the OS. Similarly, the installation of the OS switches from the second network interface module 114 to the third network interface module 116 of the available network interface modules 108 if the second network interface module 114 becomes inoperable due to an error.

In the example embodiment illustrated in FIG. 2, if the client's network interface module selected for the installation goes down (e.g., due to the error), both the installation server 104 and the client device 102 timeout after a predefined time interval has elapsed without any progress in the file-set transfer. The installation server 104 then perform a handshake with the next available client's network interface module of the client device 102 (accessible to the installation server 104), which is used to re-establish the connection. Further, installation of the OS continues with the re-transmission of the file-set whose transfer has been interrupted, thereby ensuring continuity in file-set transfer and consequently the installation of the OS.

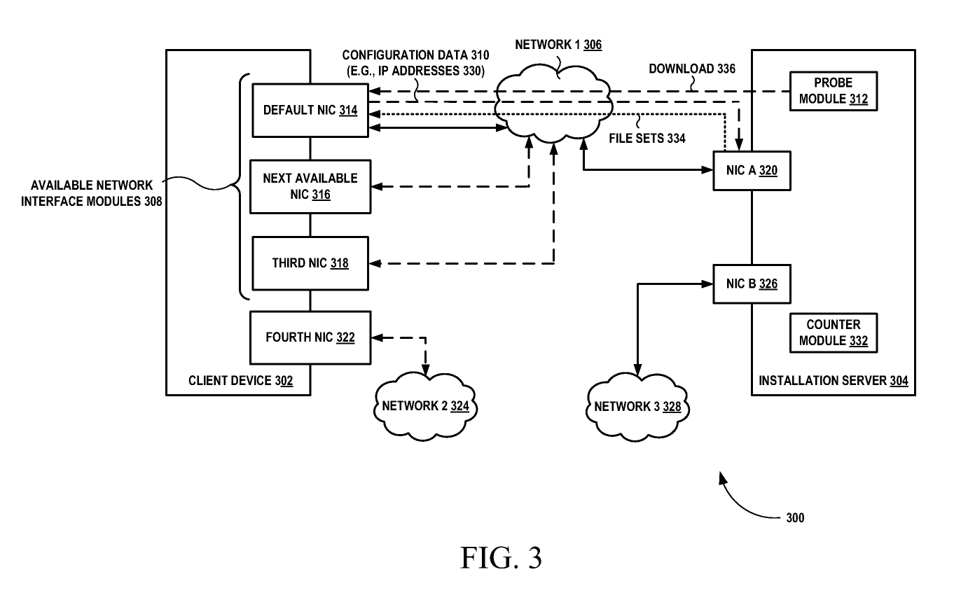

FIG. 3 is a block diagram of an exemplary network system 300 for installing an OS using a default network interface card (NIC) 314, according to one embodiment. Particularly, FIG. 3 illustrates an installation server system for installing the operating system (OS) on a client device 302 via a network (e.g., the network 1 306). As shown in FIG. 3, the exemplary network system 300 includes the client device 302, an installation server 304, and a network 1 306.

Further as shown in FIG. 3, the client device 302 includes available network interface modules 308 that are connected to the same network 1 306 as the installation server 304, and a fourth network interface card (NIC) 322 connected to a network 2 324. Furthermore, the available network interface modules 108 include a first network interface module having the default NIC 314, a second network interface module having a next available NIC 316, and a third network interface module having a third NIC 318 connected to the network 1 306.

Further as shown in FIG. 3, the installation server 304 includes a network interface card (NIC) A 320 connected to the network 1 306 and a NIC B 326 connected to the network 3 328. The installation server 304 also includes a probe module 312 and a counter module 332.

In operation, the probe module 312 determines the available network interface modules 108 having the available network interface cards (NICs) in the client device 302 when a request for an installation of the OS is forwarded by the client device 302. In one embodiment, the available network interface modules 308 include available network interface cards (NICs). In one example embodiment, the available network interface cards are determined by the probe module 312 which can scan the available network interface cards without a support of the OS.

Furthermore, the available network interface modules are scanned using respective firmware interfaces of the available network interface modules to obtain configuration data 310 (e.g., respective Internet Protocol (IP) addresses 330) of the available network interface interfaces from a dynamic host configuration protocol server.

Further, the probe module 312 is downloaded (e.g., the download 336 shown in FIG. 3) from the installation server 304 to the client device 302 using a default connection between the installation server 304 and the client device 302. Further, the installation of the OS is initiated using the default NIC 314. In one embodiment, the counter module 332 tracks a transfer of a plurality of file sets 334 to the client device 302 for the installation of the OS.

In the example embodiment illustrated in FIG. 3, the client system device 302 includes 4 NICs, out of which, 3 NICs (e.g., the default NIC 314, the next available NIC 316, and the third NIC 318) are connected to the same network (e.g., the network 1 306) as the installation server 304, using TCP/IP protocol suite, and the fourth NIC 322 is connected to another network, network 2 324. Further as shown in FIG. 3, the installation server 304 includes 2 NICs, out of which NIC A 320 is connected to same network (e.g., network 1 306) and the NIC B 326 is connected to a different network (e.g., network 3 328). Further, BOOTP is used as the protocol for communication between the installation server 304 and the client device 302, with TFTP used as a protocol for file set transmission.

Consider the installation of the OS starting with the default NIC 314 of the client device 302, establishing connection with the NIC A 320 of the installation server 304. A self-contained probe binary (i.e., the probe module 312) which can run on bare hardware (i.e., without OS support) is downloaded to the client device 302 from the installation server 304. Further, the binary probes all the available NICs in the client device 302 (e.g., using services provided by the underlying firmware) and communicates with the dynamic host configuration protocol server to get the corresponding Internet Protocol (IP) addresses for all the NIC cards which are in the same network 1 306, accessible by the installation server 304. The client device 302 communicates details back to the installation server 304. Further, installation of the OS continues with default NIC 314 associated with the client device 302. FIG. 3 illustrates installation state at the beginning of the installation.

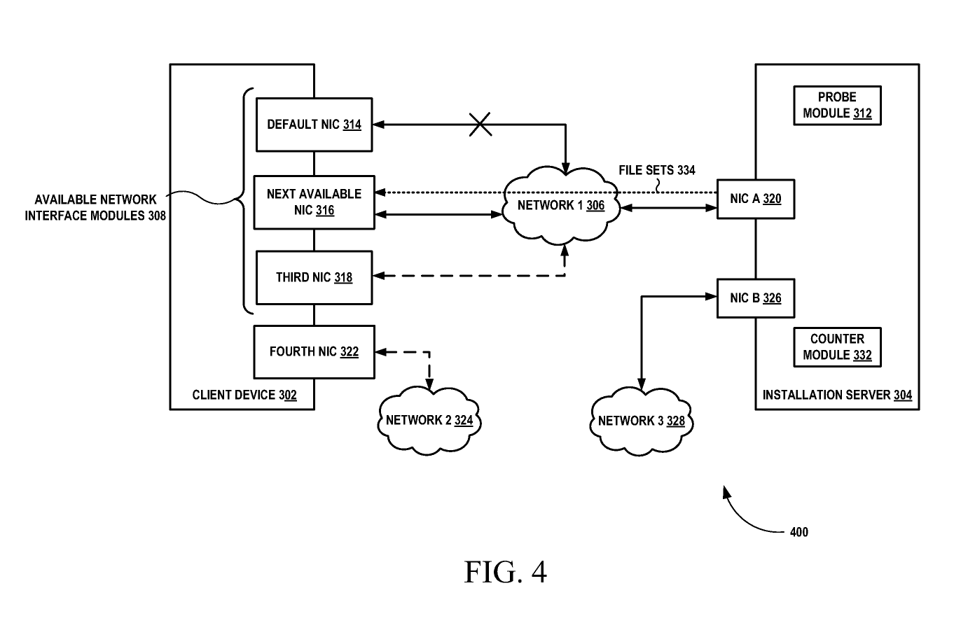

FIG. 4 is a block diagram of an exemplary network system 400 for continuing the installation of the OS using the second NIC (e.g., the next available NIC 316) when the first NIC (e.g., the default NIC 314) becomes inoperable, according to one embodiment. As shown in FIG. 4, the installation of the OS is switched from the default NIC 314 to the next available NIC 316 of the available NICs when the default NIC 314 becomes inoperable due to an error. For example, the error includes a hardware error of the default NIC 314 and/or a link connectivity failure with the default NIC 314.

In one exemplary implementation, the installation of the OS is continued using the next available NIC 316 if the transfer of the plurality of file sets 334 to the client device 302 via the default NIC 314 is not detected by the counter module 332 for more than a threshold time interval. Similarly, the installation of the OS switches from the next available NIC 316 to the third NIC 318 of the available NICs when the next available NIC 316 becomes inoperable due to an error.

In accordance with the above described embodiments in FIG. 3, when the default NIC 314 becomes unresponsive due to an error, such as a hardware malfunction or a network link connectivity issue, a failover to a next available NIC 316 for the client device 302 (e.g., which is associated with the network 1 306) occurs. Further, the transmission of the file sets 334 continues from the current file set onwards based on a counter value maintained in the counter module 332.

It is appreciated that, the failover can be continued to the third NIC 318 in case the next available NIC 316 encounters an error, since the third NIC 318 is connected to the same network 1 306. In one example embodiment, with multiple NICs connected to the same network, the failover can be continued to other NICs, in case the alternate NIC also encounters connectivity issues and so on. The pseudo-code for implementing the installation of the OS on the client device 302 is listed in APPENDIX “A” and APPENDIX “B”. In one embodiment, the Pseudo-code for implementing the functions associated with the client device 302 is listed in APPENDIX “A” and the Pseudo-code for implementing the functions associated with the Installation server 304 is listed in APPENDIX “B”.

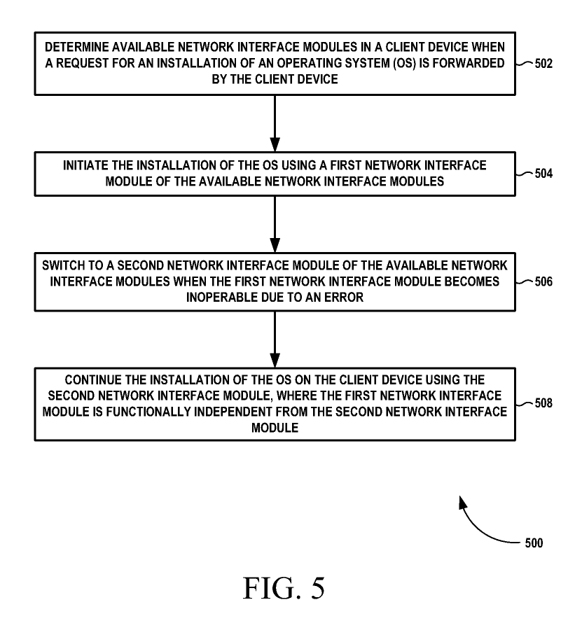

FIG. 5 is a process flow chart 500 of an exemplary method for seamlessly performing an installation of an operating system (OS) using multiple network interface modules, according to one embodiment. Particularly, FIG. 5 illustrates the method for installing the OS on a client device by an installation server via a network. Further, the pseudo-code for implementing the method of installation of the OS is listed in APPENDIX “A” and APPENDIX “B”. In step 502, available network interface modules in the client device are determined when a request for the installation of the OS is forwarded by the client device.

Further, the available network interface modules include available network interface cards (NICs). In one exemplary implementation, a first network interface module includes a default NIC, and a second network interface module includes a next available NIC. In one embodiment, the available network interface modules are determined using a probe module which is operable for scanning the available network interface modules without a support of the OS. In one exemplary implementation, the probe module is downloaded from the installation server to the client device using a default connection between the installation server and the client device.

In one example embodiment, the scanning of the available network interface modules is performed using respective firmware interfaces of the available network interface modules to obtain Internet Protocol (IP) addresses for the available network interface modules from a dynamic host configuration protocol server. In step 504, the installation of the OS is initiated using the first network interface module of the available network interface modules. Further, the installation server includes a counter module to track a transfer of a plurality of file sets to the client device during the installation of the OS.

In step 506, the installation of the OS is switched to the second network interface module of the available network interface modules when the first network interface module becomes inoperable due to an error. For example, the error comprises at least one of a hardware error of the first network interface module and a link connectivity failure with the first network interface module. In one embodiment, the installation of the OS is switched to the second network interface module if the transfer of the plurality of file sets to the client device via the first network interface module is not detected by the counter module for more than a threshold time interval.

In step 508, the installation of the OS on the client device is continued using the second network interface module. In one embodiment, the first network interface module is functionally independent from the second network interface module. In one embodiment, the installation of the OS on the client device is continued by performing a handshake between the installation server and the second network interface module, and continuing the transfer of the plurality of the file sets from the interrupted file set using the second network interface module based on the tracking of the transfer of the plurality of the file sets by the counter module.

In one exemplary implementation the initiating of the installation and the continuing of the installation are performed based on a bootstrap protocol (BOOTP). Further, the probe module and the file sets for the installation of the OS are communicated based on a trivial file transfer protocol (TFTP).

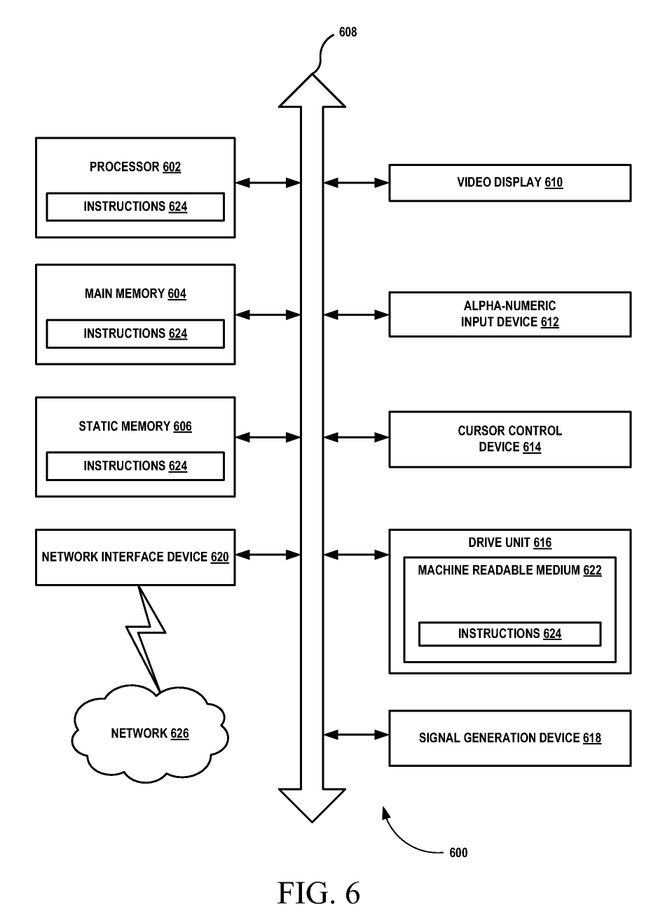

FIG. 6 is a diagrammatic system view 600 of a data processing system in which any of the embodiments disclosed herein may be performed, according to one embodiment. Particularly, the diagrammatic system view of FIG. 6 illustrates a processor 602, a main memory 604, a static memory 606, a bus 608, a video display 610, an alpha-numeric input device 612, a cursor control device 614, a drive unit 616, a signal generation device 618, a network interface device 620, a machine readable medium 622, instructions 624 and a network 626.

The diagrammatic system view 600 may indicate a personal computer and/or a data processing system in which one or more operations disclosed herein are performed. The processor 602 may be a microprocessor, a state machine, an application specific integrated circuit, a field programmable gate array, etc. The main memory 604 may be a dynamic random access memory and/or a primary memory of a computer system. The static memory 606 may be a hard drive, a flash drive, and/or other memory information associated with the data processing system.

The bus 608 may be an interconnection between various circuits and/or structures of the data processing system. The video display 610 may provide graphical representation of information on the data processing system. The alpha-numeric input device 612 may be a keypad, keyboard and/or any other input device of text (e.g., a special device to aid the physically handicapped). The cursor control device 614 may be a pointing device such as a mouse. The drive unit 616 may be a hard drive, a storage system, and/or other longer term storage subsystem.

The signal generation device 618 may be a BIOS and/or a functional operating system of the data processing system. The network interface device 620 may perform interface functions (e.g., code conversion, protocol conversion, and/or buffering) required for communications to and from the network 626 between a number of independent devices (e.g., of varying protocols). The machine readable medium 622 may provide instructions on which any of the methods disclosed herein may be performed. The instructions 624 may provide source code and/or data code to the processor 602 to enable any one or more operations disclosed herein.

For example, a computer readable medium for installing the operating system (OS) on the client device 102 via the network 1 106 having instructions that, when executed by a computer, cause the computer to perform the method including determining the available network interface modules 108 in the client device 102 when the request 110 for the installation of the OS is initiated by the client device 102, initiating the installation of the OS using the first network interface module 112 of the available network interface modules 108, switching to the second network interface module 114 of the available network interface modules 108 when the first network interface module 112 becomes inoperable due to an error, and continuing the installation of the OS on the client device 102 using the second network interface module 114. In one example embodiment, the first network interface module 112 is functionally independent from the second network interface module 114.

The above-described technique provides path failover during the installation of the OS. Further, the above-described technique does not have the OS support and needs to make available the functionality on the bare machine (with only firmware services). The above-described technique handles the scenario of network card errors during the installation, thereby reducing the overall deployment time in case of network errors during the installation. The installation of the OS automatically fails over to the next available NIC in case of network errors during the install, avoids the need for the user to be present during the installation to take care of such errors, thus minimizing explicit user intervention.

The Pseudo-code for implementing the installation of the OS is as follows.

APPENDIX “A” depicts the Pseudo-code for implementing the functions associated with the client device 102 referred as “client”.

APPENDIX “B” depicts the Pseudo-code for implementing the functions associated with the Installation server 104 referred as “server”.

Further, the foregoing described method may be in a form of a machine-readable medium embodying a set of instructions that, when executed by a machine, cause the machine to perform any method disclosed herein. It will be appreciated that the various embodiments discussed herein may not be the same embodiment, and may be grouped into various other embodiments not explicitly disclosed herein.

In addition, it will be appreciated that the various operations, processes, and methods disclosed herein may be embodied in a machine-readable medium and/or a machine accessible medium compatible with a data processing system (e.g., a computer system), and may be performed in any order (e.g., including using means for achieving the various operations). Accordingly, the specification and drawings are to be regarded in an illustrative rather than a restrictive sense.

```
APPENDIX A
Client
    {
        Power up machine
        Select NIC to be used for installation
        Dispatch request to server - (A)
        Wait for server response
        Save binary dispatched by server - (B′)
        Exec binary to probe NIC
        Dispatch NIC data to server - (C)
        Wait for fileset_count - (D′)
        Initialize received_count to zero
        While (received_count != fileset_count) {
            Wait for fileset
            If (idle wait exceeds timeout interval) {
                Check NIC status
                If (NIC unresponsive) {
                    If (No more NICs) {
                        Display error
                        Exit the install
                        }
                    Switch to next NIC
                    }
                Continue
                }
            Accept fileset [received_count] - (E′)
            If (error in fileset) {
                Send NACK to server
            Else
                Send ACK to server
                Increment fileset_count
                }
            }
        Continue with installation
    }
```

```
APPENDIX B
Server
    {
    System booted and ready
    Loop forever {
        Wait for client requests
        Accept client request - (A′)
        Dispatch binary - (B)
        Wait for client response
        Accept client NIC data - (C′)
        Dispatch fileset_count - (D)
        Initialize dispatch_count to zero
        While (dispatch_count != fileset_count) {
            Dispatch fileset [dispatch_count] - (E)
            Set timeout
            While (No response from client && timeout != expired) {
                Continue
                }
            If (client ACK) {
                Increment dispatch_count
                } else if (timeout expired) {
                    If (No more client NICs available) {
                        Display error
                        Break
                    }
                Select next client NIC
                }
            }
        End Loop
    }
```

What is claimed is:

1. A method for installing an operating system (OS) on a client device by an installation server via a network, comprising:
determining available network interface modules in the client device when a request for an installation of the OS is forwarded by the client device;
initiating the installation of the OS using a first network interface module of the available network interface modules;
switching to a second network interface module of the available network interface modules when the first network interface module becomes inoperable due to an error; and
continuing the installation of the OS on the client device using the second network interface module, wherein the first network interface module is functionally independent from the second network interface module.

2. The method of claim 1, wherein the determining of the available network interface modules is performed by a probe module which is operable for scanning the available network interface modules without a support of the OS.

3. The method of claim 2, further comprising:
downloading the probe module from the installation server to the client device using a default connection between the installation server and the client device.

4. The method of claim 2, wherein the scanning of the available network interface modules is performed using respective firmware interfaces of the available network interface modules to obtain respective Internet Protocol (IP) addresses of the available network interface modules from a dynamic host configuration protocol server.

5. The method of claim 1, further comprising:
tracking a transfer of a plurality of file sets to the client device during the installation of the OS through a counter.

6. The method of claim 5, wherein the switching to the second network interface module is performed if the transfer of the plurality of file sets to the client device via the first network interface module is not detected by the counter module for more than a threshold time interval.

7. The method of claim 6, wherein the continuing of the installation of the OS comprises:
performing a handshake between the installation server and the second network interface module; and
continuing the transfer of the plurality of the file sets from interrupted file sets using the second network interface module based on the tracking of the transfer of the plurality of the file sets by the counter module.

8. The method of claim 1, wherein the initiating of the installation and the continuing of the installation are performed based on a bootstrap protocol (BOOTP).

9. The method of claim 1, wherein the file sets for the installation of the OS are communicated based on a trivial file transfer protocol (TFTP).

10. The method of claim 1, wherein the error comprises at least one of at least one of a hardware error of the first network interface module and a link connectivity failure with the first network interface module.

11. The method of claim 1, wherein the available network interface modules comprise available network interface cards (NICs), wherein the first network interface module comprises a default network interface card (NIC), and wherein the second network interface module comprises a next available NIC.

12. An installation server system for installing an operating system (OS) on a client device via a network by initiating an installation of the OS using a first network interface module of available network interface modules in the client device and by continuing the installation of the OS using a second network interface module of the available network interface modules when the first network interface module is inoperable due to an error, the installation server system comprising:
a probe module for determining the available network interface modules in the client device when a request for the installation of the OS via the network is initiated by the client device; and
a counter module for tracking a transfer of a plurality of file sets to the client device for the installation of the OS.

13. The system of claim 12, wherein the first network interface module is functionally independent from the second network interface module.

14. The system of claim 12, wherein the probe module is operable for scanning of the available network interface modules without a support of the OS.

15. A computer readable medium for installing an operating system (OS) on a client device via a network having instructions that, when executed by a computer, cause the computer to perform a method comprising:
determining available network interface modules in the client device when a request for an installation of the OS is initiated by the client device;
initiating the installation of the OS using a first network interface module of the available network interface modules in the client device;
switching to a second network interface module of the available network interface modules in the client device when the first network interface module becomes inoperable due to an error; and
continuing the installation of the OS on the client device using the second network interface module, wherein the first network interface module is functionally independent from the second network interface module.
